(19) United States
(12) Patent Application Publication
(10) Pub. No.: US 2009/0261596 A1
(43) Pub. Date: Oct. 22, 2009

(54) WIND POWER GENERATOR

(75) Inventor: MU-CHUAN CHANG, TAINAN CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: WINDENERGY CO., LTD., TAIPEI (TW)

(21) Appl. No.: 12/104,740

(22) Filed: Apr. 17, 2008

(51) Int. Cl. F03D 9/00

(52) U.S. Cl. 290/55; 290/52

(57) ABSTRACT

A wind power generator includes a wind collecting unit, a supporting unit, a wind controller and a generator unit. The wind collecting unit includes a blade set and a supporting frame. The blade set includes a shaft and a number of blades extending from the shaft in the same direction. The supporting unit is adapted to support the wind collecting unit which is controlled by the wind controller to adjust the blade set towards the wind blowing direction. The generator unit is disposed on the shaft so as to transform the wind power into electric power and to output for energy purpose.

### BACKGROUND OF THE INVENTION

1. Field of the Invention

The present invention relates to a wind power generator, and more particularly to a generator which enables to collect the wind more efficiency and to transform the wind power into electric power.

2. Description of the Prior Art

There are tremendous demands for generators due to environment concern, such as a wind power generator which uses wind to blow blades to generate power which is then transformed into electric power. This generator is not expensive in manufacture, which does not require any fuel except scheduling maintenance, thus it has been widely adapted.

Most of the electric power factories today still rely upon nuclear energy, fuel or water as supply. The nuclear power has always concerned by people with a safety issue, fuel burning releases too much CO2, and water power damages to the nature resources.

A wind power generator has therefore been the most desirable power supply today. A conventional wind power generator comprises a blade set, a differential structure, an accelerator, a generator and a direction control. The differential structure varies the blade set sizes to receive the most wind. The direction control adjusts the blade set's direction so as to face the wind, which is then transformed through the generator into electric power. The blade set is formed with three spiral blades which are expensive and hard to maintain.

This blade set has a flat surface design, which provides a smooth flowing of wind so that the blade set may spin smoothly, however, if the wind blowing does not stable, the wind collection may not work properly, which affects the electric power supply.

### SUMMARY OF THE INVENTION

The present invention relates to a wind power generator so as to provide a more effective wind collection device and transform into electric power supply.

According to the present invention, there is provided a wind power generator comprising a wind collecting unit, said wind collecting unit comprising a blade set and a supporting frame, said blade set comprising a shaft and a number of blades extending from said shaft in the same direction, said blades being in a concave shape to form a wind collecting area, half of said blades extending outwardly from said supporting frame; a supporting unit adapted to support said wind collecting unit; a wind controller disposed on said supporting frame of said wind collecting unit; and a generator unit, said generator unit comprising a generator disposed on said shaft of said blade set, said generator being linked with said shaft of said blade set.

Preferably, said blade set is provided with a reinforcing ring around said blades.

Preferably, one end of said shaft is provided with said generator unit, the other end of said shaft is provided with a balancer having a weight equivalent to the weight of said generator unit.

Preferably, said supporting unit comprises a rod and a connecting frame, a bearing being provided between said rod and said connecting frame, said connecting frame being adapted to connect with said wind collecting unit.

Preferably, said generator unit is disposed on said shaft between two of said blades.

Preferably, said supporting frame is provided with an arcuate windshield at a front edge of said supporting frame.

It is the primary object of the present invention to provide a wind power generator, which is easy to produce and has a stronger structure.

It is another object of the present invention to provide a wind power generator, which can be an advertisement sign, street lighting device, etc.

It is a further object of the present invention to provide a wind power generator, which can supply electric power to activate a generator of a fish pond so as to prevent the user to suck underground water.

### BRIEF DESCRIPTION OF THE DRAWINGS

FIG. 1 is an exploded view of a first embodiment of the present invention;

FIG. 2 is a perspective view of the first embodiment of the present invention;

FIG. 3 is a cross-sectional view of the first embodiment of the present invention;

FIG. 4 is a cross-sectional view of the first embodiment of the present invention in an operating status;

FIG. 5 is a perspective view of a second embodiment of the present invention;

FIG. 6 is a perspective view of a third embodiment of the present invention; and

FIG. 7 is a perspective view of a fourth embodiment of the present invention.

### DETAILED DESCRIPTION OF THE PREFERRED EMBODIMENTS

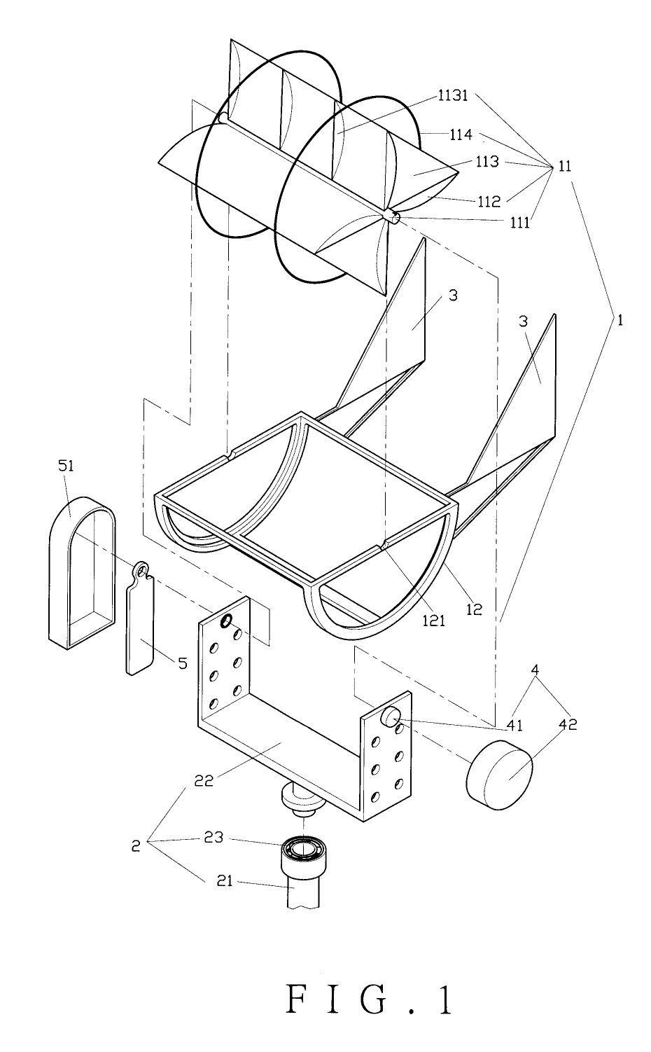

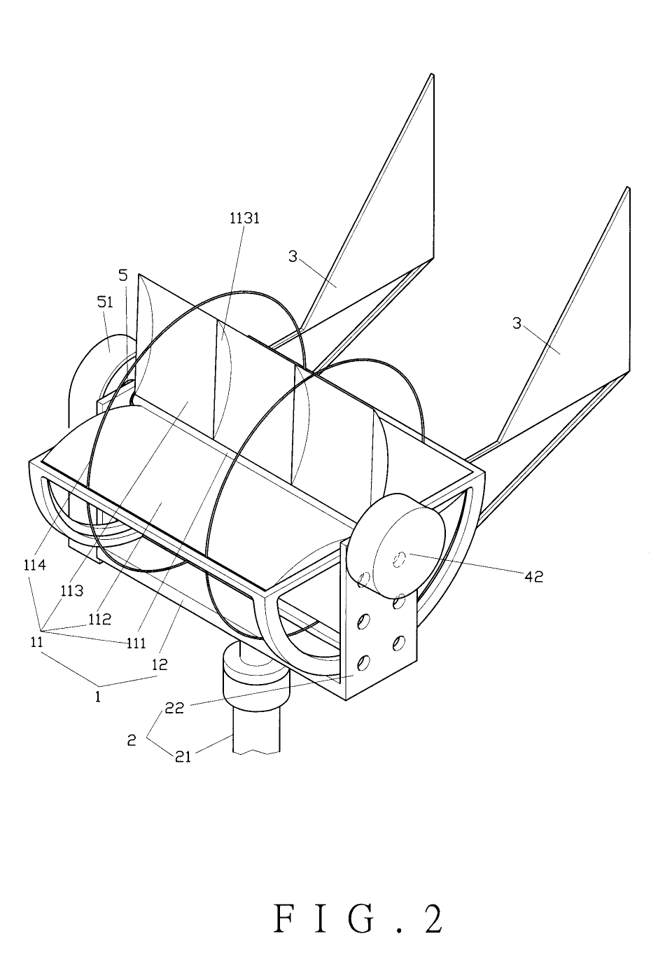

As shown in FIGS. 1 and 2, a first preferred embodiment of the present invention comprises a wind collecting unit 1, a supporting unit 2, a wind controller 3 and a generator unit 4.

The wind collecting unit 1 comprises a blade set 11 and a supporting frame 12. The blade set 11 comprises a shaft 111 and a number of blades 112 extending from the shaft 111. The blades 112 are all formed in a concave shape. Each of the blades 112 extends from the shaft 111 in the same direction with its concave to form a wind collecting area 113. A number of reinforcing ribs 1131 are provided in the wind collecting area 113. A reinforcing ring 14 is provided around the blade set 11 to strengthen the blades 112. The supporting frame 12 has a pair of holes 121 at respective sides thereof.

The supporting unit 2 comprises a rod 21 and a connecting frame 22 which is secured at one end of the rod 21. The connecting frame 22 has a U-shaped body with its two ends facing upwardly to accommodate the blade set 11. The supporting frame 12 is fixedly connected to the connecting frame 22. A bearing 23 is provided between the connecting frame 22 and the rod 21 to drive the connecting frame 22 to spin with respect to the rod 21.

The wind controller 3 is in a triangular shape and is secured to the edge of the supporting frame 12 so as to maintain the wind collecting unit 1 towards the wind blowing direction.

The generator unit 4 comprises a generator 41 and a cover 42. The generator 41 is linked with the shaft 111 of the blade set 11 and covered by the cover 42.

To assemble the present invention, both ends of the shaft 111 of the blade set 11 are connected to the holes 121 of the supporting frame 12 with half of the blades 111 extending outwardly from the supporting frame 12. The two ends of the connecting frame 22 of the supporting unit 2 are transversally connected with the shaft 111 as well. One end of the shaft 111 is provided with the generator unit 4, while the other end of the shaft 111 is provided with a balancer 5 which has a weight equivalent to the weight of the generator unit 4 to maintain the balance of the connecting frame 22. The balancer 5 is covered with a cover 51.

The supporting frame 12 provided with the wind controller 3 is fixedly connected to the connecting frame 22. When the wind changes its blowing direction, the wind controller 3 will link the supporting frame 12 to move the connecting frame 22 with respect to the rod 21 to face the wind blowing direction so that the concave of the blade 112 is constantly facing the wind direction.

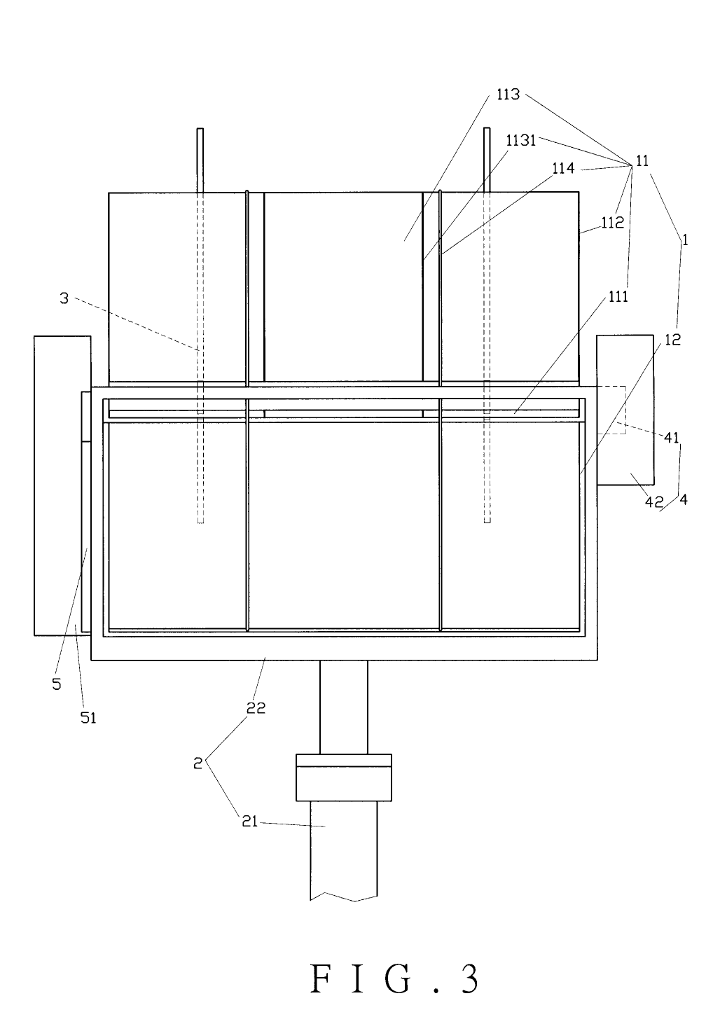

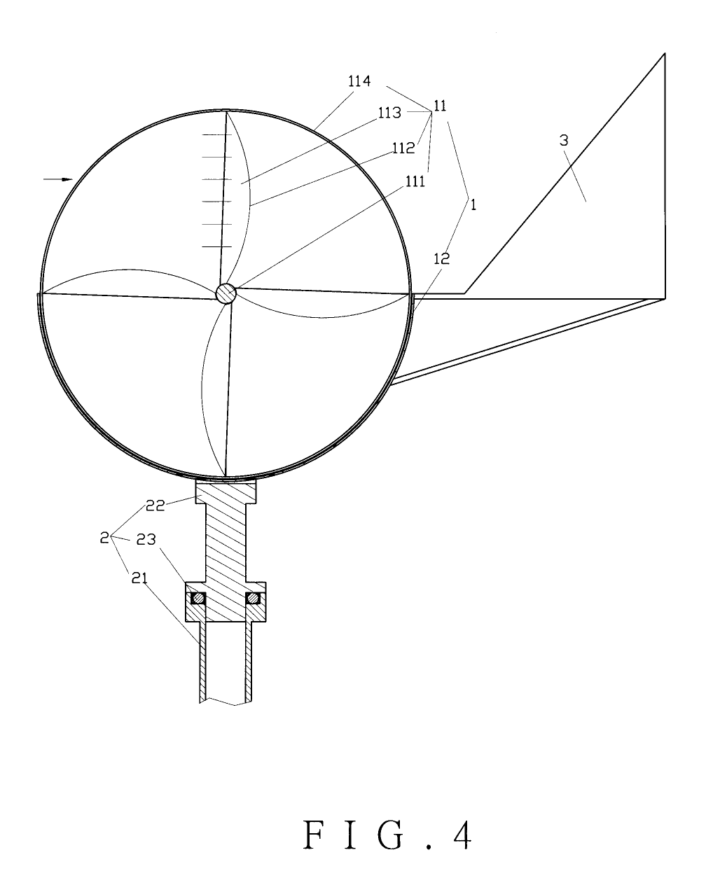

When the wind is blowing on the blade set 11, as shown in FIGS. 3 and 4, the concave shape of the blade 112 will collect the wind which then pushes the blade 112 and the shaft 111 to spin. The spinning will activate the generator 41 to transform the spinning into electric power.

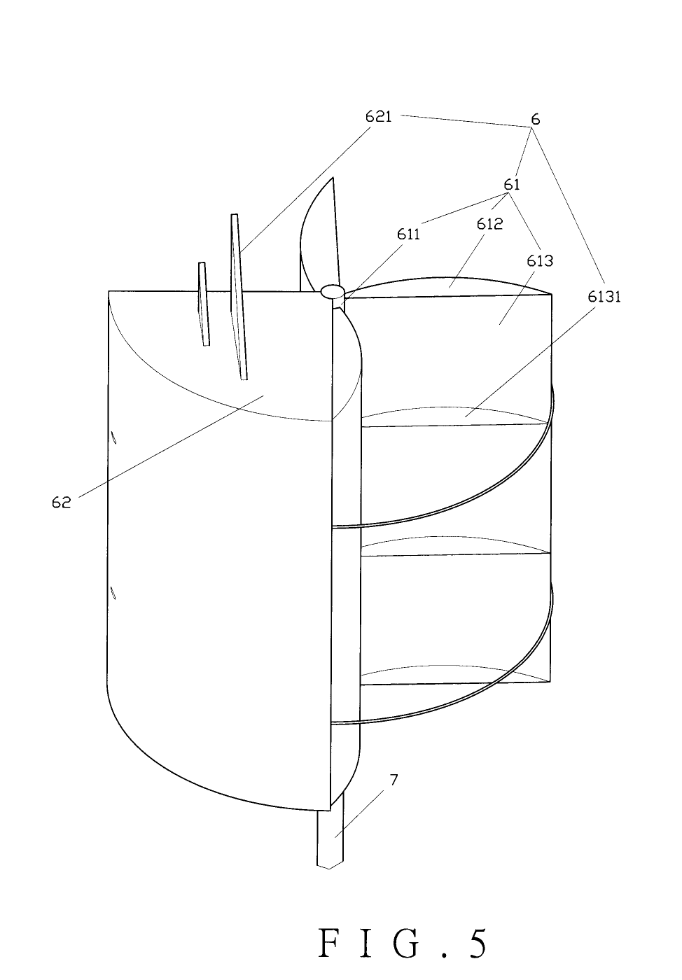

FIG. 5 shows a second embodiment of the present invention, which discloses a vertical wind power generator which comprises a wind collecting unit 6, a supporting unit 7, and a generator unit (not shown in the drawing). The wind collecting unit 6 comprises a blade set 61 and a supporting frame 62.

The blade set 61 is pivotally connected to the supporting frame 62. The supporting unit 7 is a rod which is vertically connected to the blade set 61 and the bottom of the supporting frame 62. The generator unit is disposed at the bottom of the supporting unit 7 and is linked with the blade set 61.

The supporting frame 62 is provided with a wind controller 621 which links the supporting frame 62 to spin with respect to the blade set 61 so that the wind collecting area 613 on the blade 612 starts to collect wind. The wind collecting area 613 is provided with a number of reinforcing ribs 6131. When the wind blows the blade set 61, the wind collecting area 613 will push the blade 612 to spin in the supporting frame 62, which activates the generator unit provided at the bottom of the supporting unit 7 to generate electric power.

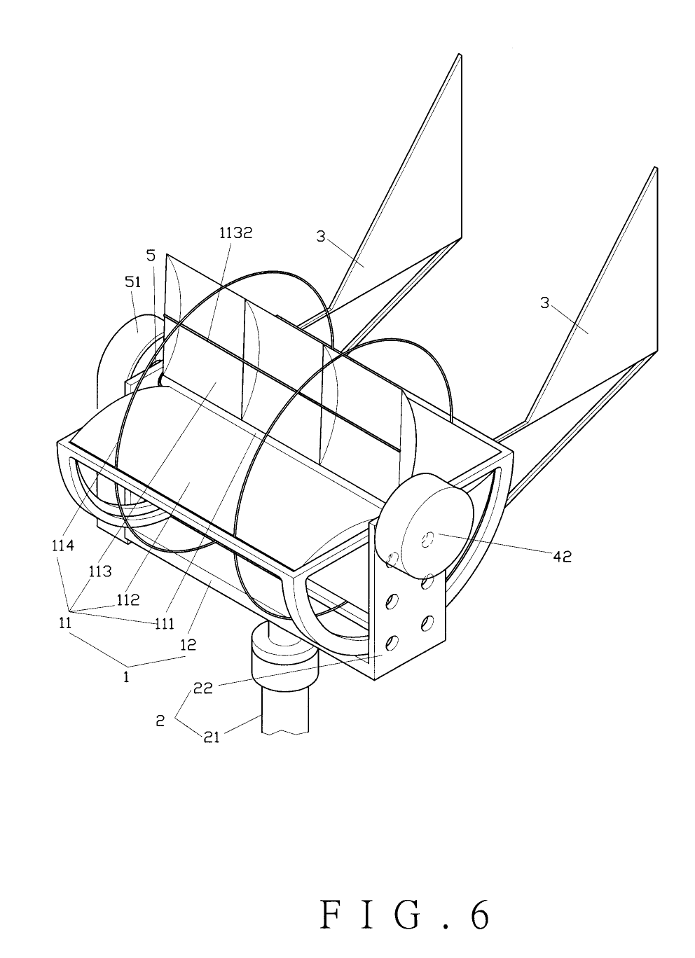

Other than the reinforcing ribs 1131 to reinforce the blades 112 of the blade set 11, a third embodiment of the present invention, as shown in FIG. 6, comprises at least one steel cable 1132 on each of the reinforcing ribs 1131. The steel cable 1132 may be welded to or inserted through the reinforcing ribs 1131.

The blades 112 and 612 of the blade sets 11 and 61 of the above-mentioned embodiments are in a concave shape to form the wind collecting areas 113 and 613, which link the blade sets 11 and 61 to spin effectively. In these embodiments, the number of blades 112 and 612 of the blade set 11 and 61 is four, which may be three or five, and is not limited.

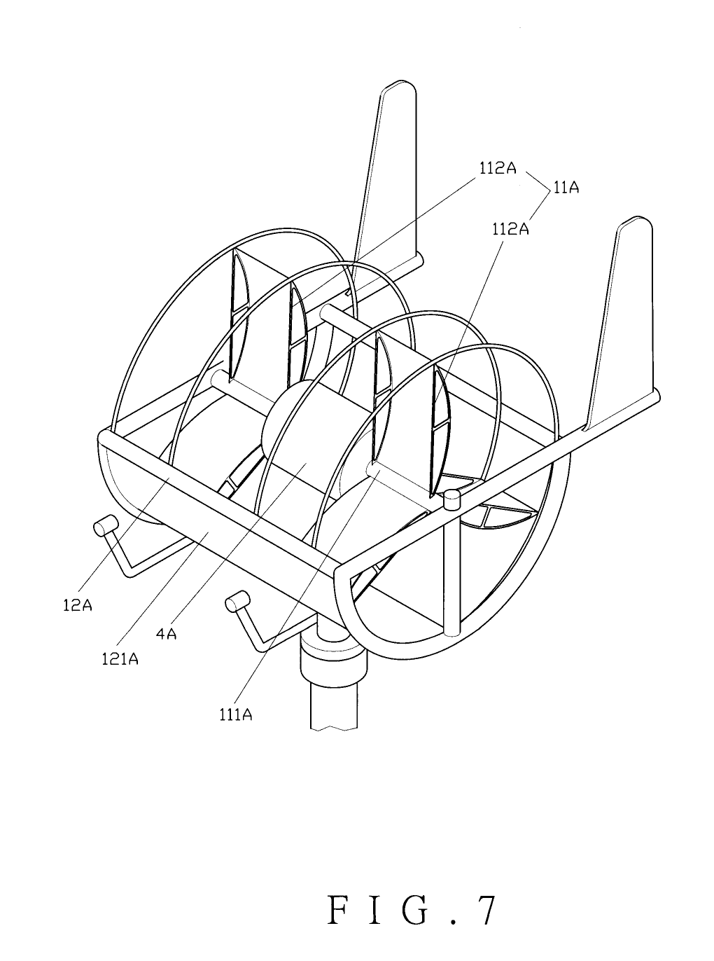

FIG. 7 shows a fourth embodiment of the present invention. The generator unit 4A may be located on the shaft 111A between two blades 112A of the blade set 11A. When the wind spins the blade set 11A with respect to the supporting frame 12A, the generator unit 4A will start to turn, which transforms the wind power into electric power. The supporting frame 12A further comprises an arcuate windshield 121A at the front edge of the supporting frame 12A.

What is claimed is:

1. A wind power generator, comprising:
a wind collecting unit, said wind collecting unit comprising a blade set and a supporting frame, said blade set comprising a shaft and a number of blades extending from said shaft in the same direction, said blades being in a concave shape to form a wind collecting area, half of said blades extending outwardly from said supporting frame;
a supporting unit adapted to support said wind collecting unit;
a wind controller disposed on said supporting frame of said wind collecting unit; and
a generator unit, said generator unit comprising a generator disposed on said shaft of said blade set, said generator being linked with said shaft of said blade set.

2. The wind power generator, as recited in claim 1, wherein said blade set is provided with a reinforcing ring around said blades.

3. The wind power generator, as recited in claim 1, wherein one end of said shaft is provided with said generator unit, the other end of said shaft is provided with a balancer having a weight equivalent to the weight of said generator unit.

4. The wind power generator, as recited in claim 1, wherein said supporting unit comprises a rod and a connecting frame, a bearing being provided between said rod and said connecting frame, said connecting frame being adapted to connect with said wind collecting unit.

5. The wind power generator, as recited in claim 1, wherein said generator unit is disposed on said shaft between two of said blades.

6. The wind power generator, as recited in claim 1, wherein said supporting frame is provided with an arcuate windshield at a front edge of said supporting frame.
